(19) United States
(12) Patent Application Publication
(10) Pub. No.: US 2009/0084884 A1
(43) Pub. Date: Apr. 2, 2009

(54) Wheelchair Fixing Apparatus And Wheelchair

(75) Inventors: Taizo Nakamura, Kanagawa (JP); Masaru Uchiyama, Miyagi (JP); Atsushi Konno, Miyagi (JP); Daisuke Sato, Tokyo (JP); Koyu Abe, Miyagi (JP)

Correspondence Address: WOLF, BLOCK, SHORR AND SOLIS-COHEN LLP, 250 PARK AVENUE, 10TH FLOOR, NEW YORK, NY, 10177, US

(73) Assignees: ANCRA JAPAN LTD., Kanagawa (JP); Tohoku University, Miyagi (JP)

(21) Appl. No.: 11/865,141

(22) Filed: Oct. 1, 2007

(51) Int. Cl. A61G 5/10; B65H 59/02

(52) U.S. Cl. 242/410; 242/155 R; 280/304.1

(57) ABSTRACT

A wheelchair fixing apparatus (2) according to the present invention includes belts (21) having connecting members (23) which can be attached to and detached from fixing hardware pieces (3) installed on a floor and winding devices (22) for winding up and accommodating the belts (21) and the winding devices (22) are disposed on the wheelchair (1). Therefore, the fixing hardware pieces (3) to which the belts (21) are connected through the connecting members (23) suffice as the floor-side equipment. Moreover, with this apparatus, a user of the wheelchair can perform the fixing operation by himself/herself. Even when a caretaker performs the operation, the burden on the caretaker in performing the operation can be reduced. Furthermore, the apparatus need not be carried by the caretaker, nor need it be ready in advance in a place where the wheelchair (1) is to be fixed.

### BACKGROUND OF THE INVENTION

1. Field of the Invention

The present invention relates to a wheelchair fixing apparatus and a wheelchair.

2. Description of the Related Art

Conventionally, as a wheelchair fixing apparatus, there is a known apparatus installed on a floor side of a vehicle or the like as disclosed in Japanese Patent Application Laid-open No. 2004-249140, for example.

However, it is a reality that the method of installing the wheelchair fixing apparatus on the floor side is difficult to familiarize because major remodeling of the existing floor is required to install the apparatus and the apparatus itself takes up a certain area of the floor even when it is not used.

On the other hand, in Japanese Patent Application Laid-open No. 2001-212179, there is disclosed a wheelchair fixing apparatus including connecting members which can be attached to and detached from fixing hardware pieces installed on a floor, belts to which the connecting members are attached, and a winding device for winding up the belts.

In this apparatus, however, the winding device is not disposed on the wheelchair and therefore a caretaker need carry the apparatus separately from the wheelchair when the apparatus is not used or the apparatus need be ready in advance in a place where the wheelchair is to be fixed.

Moreover, in the apparatus, the winding device can wind up and accommodate a tip end side of the belt disposed on a rear side of the wheelchair but cannot wind up nor accommodate a rear end side of the belt disposed on the rear side of the wheelchair and cannot wind up nor accommodate belts disposed on a front side of the wheelchair.

Furthermore, in the apparatus, the winding device need be operated on the rear side of the wheelchair and therefore a user of the wheelchair cannot operate the winding device to fix the wheelchair by himself/herself. Therefore, fixing of the wheelchair always requires a caretaker and the caretaker has to operate the winding device.

[Patent Document 1] Japanese Patent Application Laid-open No. 2004-249140

[Patent Document 2] Japanese Patent Application Laid-open No. 2001-212179

### SUMMARY OF THE INVENTION

The present invention has been made with the above circumstances in view and it is an object of the invention to provide a wheelchair fixing apparatus and a wheelchair with minimum equipment on a floor side and for improving the environment for the usage of the wheelchair.

To achieve the above object, according to the invention, there are provided the following wheelchair fixing apparatuses and wheelchair.

1. A wheelchair fixing apparatus including: a connecting member which can be attached to and detached from a fixing hardware piece installed on a floor; a linear member to which the connecting member is attached; and a winding device for winding up and accommodating the linear member, wherein the winding device is disposed on the wheelchair.

2. A wheelchair fixing apparatus according to the above item 1, wherein the winding device includes a rotor for winding up the linear member and a spring for applying rotating force in one direction to the rotor.

3. A wheelchair fixing apparatus according to the above item 1 or 2, wherein the winding device includes a pulling device for pulling the linear member in a winding-up direction.

4. A wheelchair fixing apparatus according to the above item 3, wherein the pulling device includes an operation lever provided to be swung and a one-way clutch provided between the operation lever and the rotor for winding up the linear member to transmit power to the rotor only when the operation lever is operated in one direction.

5. A wheelchair fixing apparatus according to the above item 1, wherein the winding device includes: a pulley for winding up the linear member; disc springs disposed on opposite sides of the pulley for pinching the pulley; and a rotary shaft for supporting the disc springs, the disc springs are caused to rotate by rotating the rotary shaft, the pulley rotates as the disc springs rotate, and transmission of power to the pulley is interrupted and only the disc springs rotate even if the rotary shaft is rotated when pinching forces of the disc springs reach their limits.

6. A wheelchair fixing apparatus according to the above item 5, wherein the number of the pulley provided is two, the disc springs are provided to correspond to each of the pulleys, one of the pulleys winds up one of the linear members connected to the fixing hardware piece through the connecting member on a front side or a rear side of the wheelchair, and the other pulley winds up the other linear member connected to the fixing hardware piece through the connecting member on the front side or the rear side of the wheelchair.

7. A wheelchair fixing apparatus according to the above item 5 or 6, wherein the winding device includes a spring for applying a rotating force in one direction to the rotary shaft.

8. A wheelchair fixing apparatus according to any one of the above items 5 to 7, wherein the winding device includes a pulling device for pulling the linear member in a winding-up direction.

9. A wheelchair fixing apparatus according to the above item 8, wherein the pulling device includes an operation lever provided to be swung and a one-way clutch provided between the operation lever and the rotary shaft to transmit power to the rotary shaft only when the operation lever is operated in one direction.

10. A wheelchair fixing apparatus according to any one of the above items 1 to 9, wherein the winding device includes a lock mechanism for preventing the linear member from being drawn out and a canceling mechanism for canceling a locked state by the lock mechanism.

11. A wheelchair fixing apparatus according to the above item 10, wherein the canceling mechanism can maintain a cancelled state.

12. A wheelchair fixing apparatus according to any one of the above items 1 to 11, wherein the winding device is disposed at a lower portion of an armrest of the wheelchair.

13. A wheelchair fixing apparatus according to any one of the above items 1 to 12, wherein the connecting member includes an engagement portion to be engaged with the fixing hardware piece and a handle provided at its tip end with the engagement portion.

14. A wheelchair fixing apparatus according to the above item 13, wherein the handle is telescopic.

15. A wheelchair including the wheelchair fixing apparatus according to any one of the above items 1 to 14.

With the invention according to the above item 1, the apparatus includes the connecting member which can be attached to and detached from the fixing hardware piece installed on the floor, the linear member to which the connecting member is attached, and the winding device for winding up and accommodating the linear member and the winding device is disposed on the wheelchair. Therefore, the fixing hardware piece to which the linear member is connected through the connecting member suffice as the floor-side equipment. As a result, the equipment is easy to introduce to a new floor and also an existing floor can be remodeled by easy operation and at low cost. Furthermore, when the apparatus is not used, only the fixing hardware piece exists on the floor and the apparatus itself does not take up a certain area of the floor.

Here, the word “floor” refers to a place where the wheelchair is to be fixed. Typical floors are a floor of a vehicle such as a train, an electric train, a bus, and an automobile and a floor of a building such as a store, a theater, and a hall, but the floor is not limited to them. The words “linear member” used here include belts, wire ropes, and the like.

With the invention, the wheelchair can be fixed by only withdrawing the linear member from the winding device and connecting the linear member to the fixing hardware piece through the connecting member and the operation is easy. Therefore, a user of the wheelchair can perform the fixing operation by himself/herself. Even in a case in which a caretaker (including a person who is not attending on the user for the purpose of care) performs the operation, the burden on the caretaker in performing the operation can be reduced. Moreover, the apparatus need not be carried by a caretaker, nor need it be ready in advance in a place where the wheelchair is to be fixed.

Consequently, with the invention, because the floor-side equipment can be minimized and the user of the wheelchair can fix the wheelchair alone or the caretaker can fix the wheelchair with a light burden, it is possible to improve the environment for the usage of the wheelchair.

With the invention according to the above item 2, the winding device includes the rotor for winding up the linear member and the spring for applying the rotating force in one direction to the rotor. Therefore, by the rotating force applied by the spring, the rotor constantly try to rotate in one direction and the linear member is wound up by the rotor as the rotor rotates in one direction. Consequently, in a state in which the linear member is connected to the fixing hardware piece through the connecting member, the slack can be taken out of the linear member and tension can be generated in the linear member. On the other hand, if the connection between the fixing hardware piece and the connecting member is cancelled, the linear member is quickly wound up by the rotor and accommodated by the winding device.

With the invention according to the above item 3, the winding device includes the pulling device for pulling the linear member in the winding-up direction. Therefore, by operating the pulling device to pull the linear member in the winding-up direction, the tension generated in the linear member can be further increased. As a result, it is possible to firmly fix the wheelchair.

With the invention according to the above item 4, the pulling device includes an operation lever provided to be swung and a one-way clutch provided between the operation lever and the rotor for winding up the linear member to transmit power to the rotor only when the operation lever is operated in one direction. Therefore, by only repeating simple and easy operation in which the operation lever is operated in one direction and then operated in the reverse direction, it is possible to increase tension generated in the linear member.

With the invention according to the above item 5, the winding device includes: the pulley for winding up the linear member; the disc springs disposed on the opposite sides of the pulley for pinching the pulley; and the rotary shaft for supporting the disc springs, the disc springs are caused to rotate by rotating the rotary shaft, the pulley rotates as the disc springs rotate, and transmission of power to the pulley is interrupted and only the disc springs rotate even if the rotary shaft is rotated when pinching forces of the disc springs reach their limits. Therefore, excessive loads on the pulley and the like can be prevented and therefore it is possible to prevent damage to the apparatus. Moreover, the tension generated in the linear member can be set of a predetermined value.

With the invention according the above item 6, the number of the pulley provided is two, the disc springs are provided to correspond to each of the pulleys, one of the pulleys winds up one of the linear members connected to the fixing hardware piece through the connecting member on the front side or the rear side of the wheelchair, and the other pulley winds up the other linear member connected to the fixing hardware piece through the connecting member on the front side or the rear side of the wheelchair. Therefore, both of the linear members connected to the fixing hardware pieces through the connecting members can be wound up on the front side or the rear side of the wheelchair by the one winding device to thereby enhance ease of operation. Moreover, the tension generated in one of the linear members and that in the other can be equalized and therefore it is possible to fix the wheelchair in balance.

With the invention according to the above item 7, the winding device includes the spring for applying the rotating force in one direction to the rotary shaft. Therefore, by the rotating force applied by the spring, the rotary shaft constantly tries to rotate in one direction and the linear member is wound up by the pulley as the rotary shaft rotates in one direction. Consequently, in a state in which the linear member is connected to the fixing hardware piece through the connecting member, the slack can be taken out of the linear member and tension can be generated in the linear member. On the other hand, if the connection between the fixing hardware piece and the connecting member is cancelled, the linear member is quickly wound up by the pulley and accommodated by the winding device.

With the invention according to the above item 8, the winding device includes the pulling device for pulling the linear member in the winding-up direction. Therefore, by operating the pulling device to pull the linear member in the winding-up direction, the tension generated in the linear member can be further increased. As a result, it is possible to firmly fix the wheelchair.

With the invention according to the above item 9, the pulling device includes the operation lever provided to be swung and the one-way clutch provided between the operation lever and the rotary shaft to transmit power to the rotary shaft only when the operation lever is operated in one direction. Therefore, by only repeating simple and easy operation in which the operation lever is operated in one direction and then operated in the reverse direction, it is possible to increase tension generated in the linear member.

With the invention according to the above item 10, the winding device includes a lock mechanism for preventing drawing out of the linear member and a canceling mechanism for canceling a locked state by the lock mechanism. Therefore, by operation of the lock mechanism for preventing the linear member from being drawn out, it is possible to prevent the linear member from slacking after the wheelchair is fixed by using the linear member. To draw the linear member out of the winding device, it is possible to easily draw out the linear member by canceling the locked state by the lock mechanism by using the canceling mechanism.

With the invention according to the above item 11, the canceling mechanism can maintain the cancelled state. Therefore, only one hand is necessary for operation in drawing the linear member out of the winding device.

With the invention according to the above item 12, the winding device is disposed at the lower portion of the armrest of the wheelchair. Therefore, point on which the linear member act is located not at lower portion of the wheelchair but at the lower portion of the armrests and the linear member can act on higher position of the wheelchair. Therefore, it is possible to generate fixing force that can sufficiently resist a horizontal load and a vertical load (and especially a load acting in an opposite direction to a direction of gravity) applied to the wheelchair.

With the invention according to the above item 13, the connecting member includes the engagement portion to be engaged with the fixing hardware piece and the handle provided at its tip end with the engagement portion. Therefore, it is possible to grip the handle and attach the connecting member to the fixing hardware piece. Consequently, it is possible to attach the connecting member to the fixing hardware piece without bending a body so much to the front or the rear and therefore a user of the wheelchair who has difficulty in bending his/her upper body can fix the wheelchair alone.

With the invention according to the above item 14, the handle is telescopic. Therefore, it is possible to make the handle shorter and to make the connecting member smaller to accommodate or carry the member when it is not used.

With the invention according to the above item 15, the wheelchair includes the wheelchair fixing apparatus according to any one of the above items 1 to 14. Therefore, it is possible to provide the wheelchair having the effects of the above inventions.

### BRIEF DESCRIPTION OF THE DRAWINGS

FIG. 1 is a drawing showing a state in which a wheelchair according to an embodiment 1 is fixed onto a floor.

FIG. 2 is a perspective view showing a winding device employed in the embodiment 1.

FIG. 3 is a drawing showing an inner structure of the winding device employed in the embodiment 1.

FIG. 4 is a drawing for explaining structures of a lock mechanism and a canceling mechanism employed in the embodiment 1.

FIG. 5 is a drawing showing a state in which a wheelchair according to an embodiment 2 is fixed onto a floor.

FIG. 6 is a drawing showing an inner structure of a winding device employed in the embodiment 2.

FIG. 7 is a drawing for explaining structures of a lock mechanism and a canceling mechanism employed in the embodiment 2.

FIG. 8 is a drawing showing a state in which a cover is mounted to a pulley employed in the embodiment 2.

### EXPLANATION OF REFERENCE NUMERALS

wheelchair

1a, 1b armrest

wheelchair fixing apparatus

linear member

21a, 21b front belt

21c, 21d rear belt

21e, 21f front wire

21g, 21h rear wire

winding device

rotor

221a first rotor

221b second rotor

spring

pulling device

223a operation lever

223b one-way clutch

lock mechanism

224a guide

224b eccentric cam

224c spring

224d ratchet

224e pawl

224f stopper

canceling mechanism

225a bolt

225b bolt retaining portion

225c, 225d operation portion

pulley

226a first pulley

226b second pulley

disc spring

rotary shaft

cover

229a opening portion

connecting member

23a to 23d, 23g hook

23e engagement portion

23f handle

24a, 24b guide

fixing hardware piece

3a, 3b rail member

3c, 3d hook holder

### DETAILED DESCRIPTION OF PREFERRED EMBODIMENTS

Modes for carrying out the present invention will be described below according to embodiments shown in the drawings.

### Embodiment 1

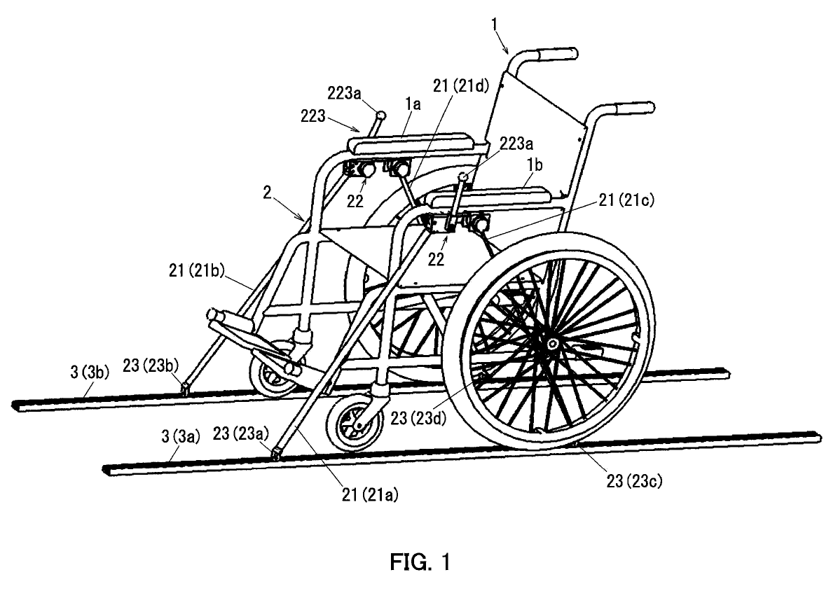

FIG. 1 is a drawing showing a state in which a wheelchair 1 according to the embodiment 1 of the invention is fixed onto a floor. As shown in this drawing, the wheelchair 1 according to the present embodiment includes a wheelchair fixing apparatus 2 having linear members 21 and winding devices 22.

Used as linear members 21 forming the wheelchair fixing apparatus 2 are two belts 21a, 21b (hereafter referred to as “front belts”) disposed on a front side of the wheelchair 1 and two belts 21c, 21d (hereafter referred to as “rear belts”) disposed on a rear side of the wheelchair 1 when they are used. The front belts 21a, 21b and the rear belts 21c, 21d are respectively provided with connecting members 23 which can be attached to and detached from fixing hardware pieces 3 installed on the floor. It is essential only that the fixing hardware pieces 3 and the connecting members 23 be capable of being connected to and separated from each other and their shapes and structures are not limited at all. In the embodiment, rail members 3a, 3b having grooves are employed as the fixing hardware pieces 3, and hooks 23a to 23d which can be attached to and detached from the grooves of the rail members 3a, 3b are employed as the connecting members 23.

Although the winding devices 22 are preferably able to wind up and accommodate both the front belts 21a, 21b and rear belts 21c, 21d but may be able to wind up and accommodate the front belts 21a, 21b or the rear belts 21c, 21d. In the embodiment, devices which can wind up and accommodate both the front belts 21a, 21b and rear belts 21c, 21d are employed as the winding devices 22.

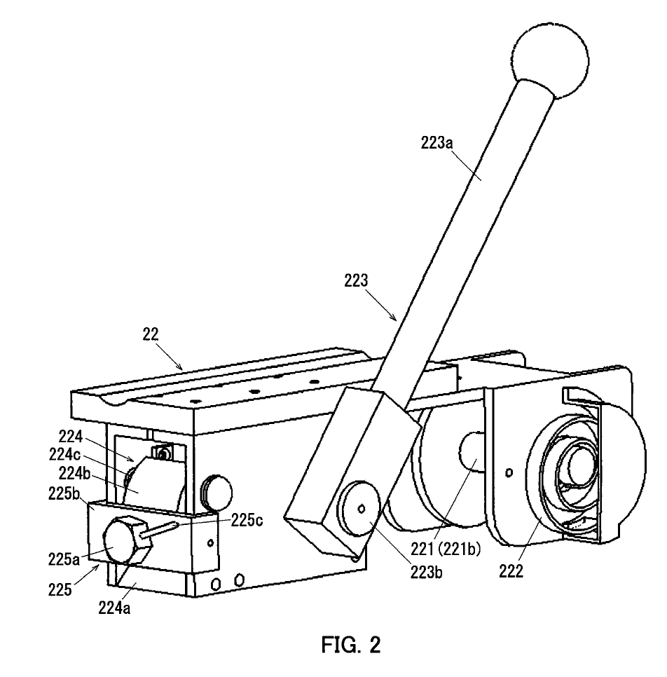

Each of the winding devices 22 employed in the embodiment includes rotors 221, springs 222, a pulling device 223, a lock mechanism 224, and a canceling mechanism 225 as shown in FIGS. 2 to 4.

The rotors 221 have functions of winding up the linear members 21 and may be in any shapes. In the embodiment, two rotors 221 are provided to correspond to the front belt 21a or 21b and the rear belt 21c or 21d functioning as the linear members 21, respectively.

The rotor 221a (hereafter referred to as “first rotor”) corresponding to the front belt 21a or 21b is mounted with an end portion of the front belt 21a or 21b and the front belt 21a or 21b is wound up by the first rotor 221a as the first rotor 221a rotates in one direction. On the other hand, the rotor 221b (hereafter referred to as “second rotor”) corresponding to the rear belt 21c or 21d is mounted with an end portion of the rear belt 21c or 21d and the rear belt 21c or 21d is wound up by the second rotor 221b as the second rotor 221b rotates in one direction.

The springs 222 have functions of applying rotating forces in one direction to the rotors 221. In the embodiment, spiral springs are used as the springs 222 and two springs 222 are provided to respectively act on the first rotor 221 a and the second rotor 221b.

The pulling device 223 has a function of pulling the linear members 21 in the winding-up direction and a structure of the device 223 is not restricted as far as it can perform the function. Therefore, a structure for directly or indirectly applying rotating forces in one direction to the rotors 221 may be employed or a structure that directly acts on the linear members 21 may be employed as the pulling device 223.

The pulling device 223 employed in the embodiment includes an operation lever 223a and a one-way clutch 223b. The operation lever 223a is in a shape of a rod and coupled to the first rotor 221a through the one-way clutch 223b. The operation lever 223a can be swung and power for rotating the first rotor 221 a is generated by operating the operation lever 223a. The one-way clutch 223b exists between the operation lever 223a and the first rotor 221a and has a function of transmitting the power to the first rotor 221a only when the operation lever 223a is operated in one direction.

With this pulling device 223, when the operation lever 223a is operated in one direction, the one-way clutch 223b is driven to transmit the power generated by the movement of the operation lever 223a to the first rotor 221a to thereby rotate the first rotor 221a in one direction. As a result, the front belt 21a or 21b functioning as the linear member 21 is pulled in the wound-up direction. On the other hand, when the operation lever 223a is operated in a reverse direction, the one-way clutch 223b idles and the power generated by the movement of the operation lever 223a is not transmitted to the first rotor 221a. Therefore, the first rotor 221a does not rotate and the front belt 21a or 21b is not pulled in.

If this pulling device 223 is used, by only repeating simple and easy operation in which the operation lever 223a is swung, i.e., the operation lever 223a is operated in one direction and then operated in the reverse direction, it is possible to increase tension generated in the front belt 21a or 21b.

The lock mechanism 224 has a function of preventing the linear member 21 from being drawn out. The lock mechanism 224 may be a mechanism that can prevent drawing in of the linear member 21 when the linear member 21 is drawn in the wound-up direction. However, if such a lock mechanism is employed, the lock mechanism need be provided not to either one of the front belt 21a or 21b and the rear belt 21c or 21d but to each of them. In other words, if such a lock mechanism is provided to only the front belt 21a or 21b, the wheelchair 1 moves forward and the front belt 21a or 21b slacks when a large horizontal load is applied to the wheelchair 1 from behind and, as a result, the rear belt 21c or 21d is drawn out and slacks, because the front belt 21a or 21b is not wound up by the operation of the lock mechanism. In order to avoid occurrence of this event, the lock mechanism having the same structure may be provided to the rear belt 21c or 21d to prevent drawing out of the rear belt 21c or 21d when the large horizontal load is applied to the wheelchair 1 from behind. In this case, however, the number of parts increases and the apparatus becomes large in size. Consequently, it is preferable to employ, as the lock mechanism 224, the mechanism for allowing drawing in of the linear member 21 when it is drawn in the wound-up direction and for preventing the linear member 21 from being drawn out when it is drawn out in a direction reverse to the wound-up direction. In this way, it is possible to reduce the number of parts and to make the apparatus small in size.

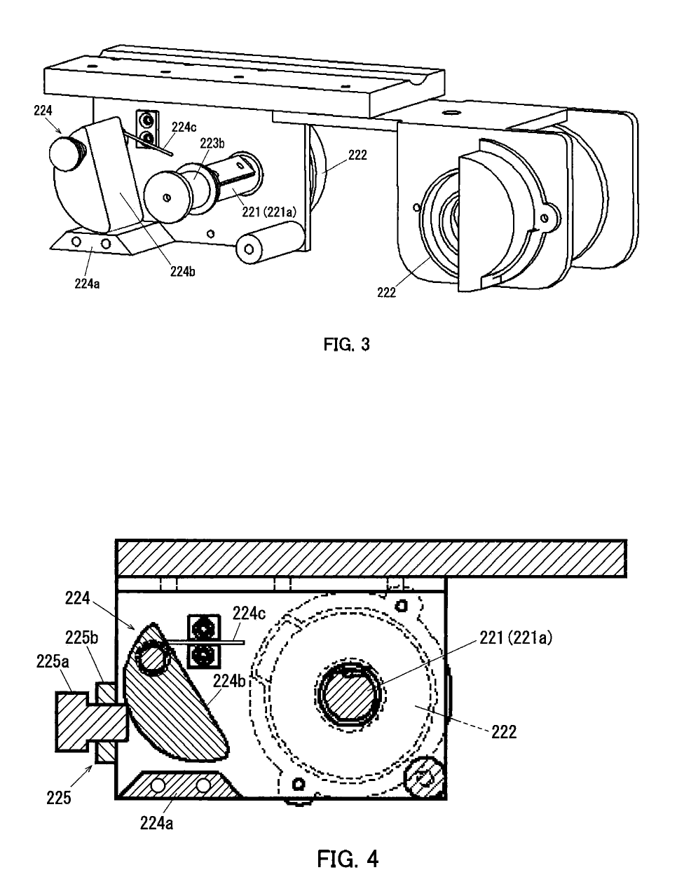

The lock mechanism 224 employed in the embodiment has a function of preventing only drawing out of the linear member 21 and includes a guide 224a, an eccentric cam 224b, and a spring 224c as shown in FIGS. 3 and 4. The eccentric cam 224b is disposed on the guide 224a and the spring 224c is provided to be able to apply rotating force in one direction to the eccentric cam 224b. In the wheelchair fixing apparatus 2 employed in the embodiment, the lock mechanisms 224 are provided to only the front belts 21a, 21b functioning as the linear members 21 and the front belt 21a or 21b is inserted through between the eccentric cam 224b and the guide 224a. In a locked state, the eccentric cam 224b comes in pressure contact with the front belt 21a or 21b existing on the guide 224a to prevent drawing out of the front belt 21a or 21b with the pressing force of the eccentric cam 224b and frictional force generated when the front belt 21a or 21b is pulled to be drawn out. On the other hand, even in the locked state, the frictional force generated between the eccentric cam 224b and the front belt 21a or 21b is small when the front belt 21a or 21b is drawn in the wound-up direction, because the eccentric cam 224b has a substantially semicircular shape in a side view and its curved face faces the drawn-out direction of the front belt 21a or 21b. Therefore, the front belt 21a or 21b is wound up by the first rotor 221a. As a result, even if the large horizontal load is applied to the wheelchair 1 from behind and, as a result, the rear belt 21c or 21d is drawn out, the front belt 21a or 21b is wound up by the first rotor 221a and therefore the front belt 21a or 21b does not slack when the wheelchair 1 moves forward.

The canceling mechanism 225 has a function of canceling a locked state by the lock mechanism 224 and a structure of the canceling mechanism 225 is not restricted as far as it can perform the function. However, as the canceling mechanism 225, the mechanism having a structure that can maintain the cancelled state is preferable. In other words, if the lock mechanism 224 is actuated to lock the linear member when a hand for operating an operation portion of the canceling mechanism is released from the operation portion, both hands are always necessary for operation, i.e., one hand for operating the operation portion of the canceling mechanism and the other for holding the linear member 21. In this regard, with the canceling mechanism 225 that can maintain the cancelled state, the cancelled state is maintained and the linear member is not locked even if the hand for operating the operation portion of the canceling mechanism 225 is released from the operation portion. Therefore, only one hand is necessary for operation in drawing the linear member 21 out of the winding device 22.

The canceling mechanism 225 employed in the embodiment includes a bolt 225a disposed in such a position as to face the eccentric cam 224b, a bolt retaining portion 225b having a screw hole in which the bolt 225a is coupled, and an operation portion 225c provided to protrude from a head portion of the bolt 225a and can maintain the cancelled state by coupling between an external thread formed on the bolt 225a and an internal thread formed in the screw hole as shown in FIGS. 2 and 4.

In other words, in the canceling mechanism 225, by operating the operation portion 225c in one direction, the bolt 225a rotates in one direction and a tip end of the bolt 225a advances while in contact with the eccentric cam 224b to thereby push up the eccentric cam 224b. As a result, a clearance created between the eccentric cam 224b and the guide 224a is widened to cancel the locked state by the lock mechanism 224. Then, if the hand for operating the operation portion 225c is released from the operation portion 225c, the cancelled state is maintained, because the bolt 225a is coupled in the screw hole in the bolt retaining portion 225b and does not rotate in a reverse direction unless it receives external force. On the other hand, if the operation portion 225c is operated in the reverse direction, the bolt 225a rotates in the reverse direction and the tip end of the bolt 225a recedes and therefore the eccentric cam 224b rotates downward. As a result, the clearance created between the eccentric cam 224b and the guide 224a is narrowed to lock the linear member.

The winding devices 22 of the wheelchair fixing apparatus 2 formed as described above are disposed at lower portions of armrests 1a and 1b of the wheelchair 1 as shown in FIG. 1. By disposing the winding devices 22 at the lower portions of the armrests 1a and 1b of the wheelchair 1 in this manner, points on which the linear members 21 act are located not at lower portions of the wheelchair 1 but at the lower portions of the armrests 1a and 1b and the linear members 21 can act on higher positions of the wheelchair 1. Therefore, it is possible to generate fixing force that can sufficiently resist a horizontal load and a vertical load (and especially a load acting in an opposite direction to a direction of gravity) applied to the wheelchair 1. On the other hand, the front belts 21a, 21b and the rear belts 21c, 21d functioning as the linear members 21 are respectively wound up and accommodated by the first rotors 221a and the second rotors 221b when they are not used. Therefore, the wheelchair fixing apparatus 2 need not be carried by a caretaker, nor need it be ready in advance in a place where the wheelchair 1 is to be fixed.

The wheelchair 1 according to the embodiment is used as follows. To fix the wheelchair 1 onto the floor, the rear belts 21c, 21d accommodated in the winding devices 22 are first drawn out and the hooks 23c, 23d provided to tip ends of the rear belts 21c, 21d are connected to rail members 3a, 3b installed on the floor. Next, the operation portions 225c of the canceling mechanism 225 are moved in one direction to rotate the bolts 225a in one direction. In this way, the locked states by the lock mechanisms 224 are cancelled and the front belts 21a, 21b accommodated in the winding devices 22 can be drawn out. Then, the front belts 21a, 21b accommodated in the winding devices 22 are drawn out and the hooks 23a, 23b provided to tip ends of the front belts 21a, 21b are connected to the rail members 3a, 3b installed on the floor. At last, the operation portions 225c of the canceling mechanisms 225 are moved in the reverse directions to rotate the bolts 225a in the reverse directions. As a result, the lock mechanisms 224 are actuated to lock the front belts 21a, 21b and drawing out of the front belts 21a, 21b is prevented.

When the front belts 21a, 21b and the rear belts 21c, 21d are connected to the rail members 3a, 3b through the hooks 23a to 23d in the above manner, tension is generated in each of the front belts 21a, 21b and the rear belts 21c, 21d. In other words, the winding devices 22 employed in the embodiment include the rotors 221 for rotating in one direction to thereby wind up the linear members 21 and the springs 222 for applying the rotating forces in one direction to the rotors 221. Therefore, if the rear belts 21c, 21d and the front belts 21a, 21b are drawn out of the winding devices 22, forces for rotating the first rotors 221a and the second rotors 221b are stored in the springs 222. Then, when the hooks 23a to 23d are connected to the rail members 3a, 3b and drawing out of the front belts 21a, 21b and the rear belts 21c, 21d is completed, the forces stored in the springs 222 are released and the first rotors 221a and the second rotors 221b respectively rotate in one direction to draw in the front belts 21a, 21b and the rear belts 21c, 21d in the winding-up directions. Therefore, in the state in which the front belts 21a, 21b and the rear belts 21c, 21d are connected to the rail members 3a, 3b through the hooks 23a to 23d, the slack is taken out of each of the front belts 21a, 21b and rear belts 21c, 21d by the operation of the springs 222 and the tension is generated in each of the front belts 21a, 21b and rear belts 21c, 21d.

To further increase the force for fixing the wheelchair 1, the operation levers 223a forming the pulling devices 223 are swung. As a result, the first rotors 221a rotate in one direction to wind up the front belts 21a, 21b and therefore the tension generated in each of the front belts 21a, 21b and rear belts 21c, 21d is further increased to firmly fix the wheelchair 1.

According to the wheelchair 1 of the embodiment, because the winding devices 22 are disposed at the lower portions of the armrests 1a and 1b and the operation levers 223a are under hands of the user of the wheelchair, the user of the wheelchair can operate the operation levers 223a by himself/herself. This is also true of operation of the operation portions 225c of the canceling mechanisms 225 and drawing out of the front belts 21a, 21b and the rear belts 21c, 21d described above. Therefore, the user of the wheelchair can perform the fixing operation by himself/herself. Even in a case in which a caretaker (including a person who is not attending on the user for the purpose of care) performs the fixing operation of the wheelchair 1, the operation is easy and therefore the burden on the caretaker in performing the operation can be reduced.

Moreover, according to the wheelchair 1 of the embodiment, the fixing hardware pieces 3 to which the linear members 21 are connected through the connecting members 23 suffice as the floor-side equipment and it is possible to minimize the floor-side equipment. Therefore, the equipment is easy to introduce to a new floor and also an existing floor can be remodeled by easy operation and at low cost. Furthermore, when the wheelchair fixing apparatus 2 is not used, only the fixing hardware pieces 3 exist on the floor and the wheelchair fixing apparatus 2 itself does not take up a certain area of the floor. Therefore, it is possible to improve the environment for the usage of the wheelchair 1.

### Embodiment 2

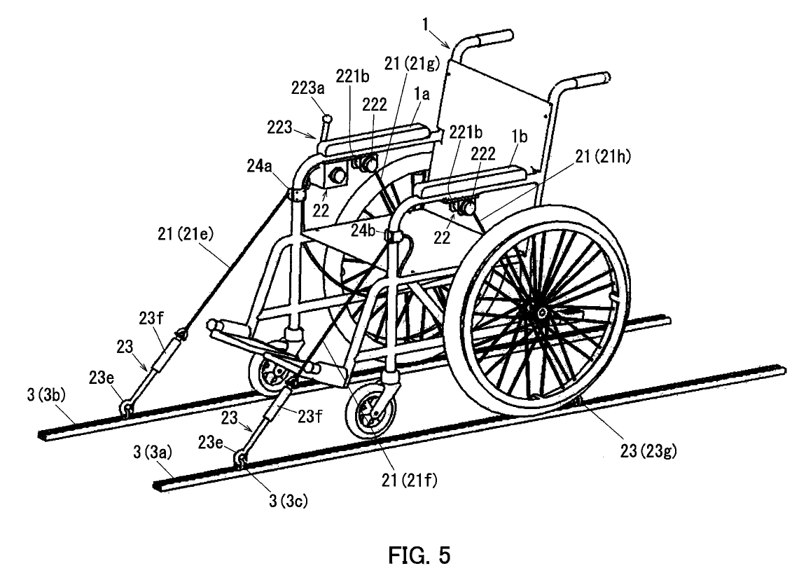

FIG. 5 is a drawing showing a state in which a wheelchair 1 according to the embodiment 2 is fixed onto a floor. As shown in this drawing, the wheelchair 1 according to the present embodiment also includes the wheelchair fixing apparatus 2 having the linear members 21 and the winding devices 22 similarly to the wheelchair 1 according to the embodiment 1.

Used as the linear members 21 are two wire ropes 21e, 21f (hereafter referred to as “front wires”) disposed on a front side of the wheelchair 1 and two wire ropes 21g, 21h (hereafter referred to as “rear wires”) disposed on a rear side of the wheelchair 1 when they are used. The front wires 21e, 21f and the rear wires 21g, 21h are respectively provided with connecting members 23 which can be attached to and detached from fixing hardware pieces 3 installed on the floor. In the embodiment, hook holders 3c, 3d are mounted in advance to rail members 3a, 3b used as the fixing hardware pieces 3. Each of the connecting members 23 provided to the front wires 21e, 21f includes an engagement portion 23e engaged with the hook holder 3c or 3d functioning as the fixing hardware piece 3 and a handle 23f provided at its tip end with the engagement portion 23e. Here, it is preferable that the handle 23f is telescopic. If the handle 23f is telescopic, it is possible to make the handle 23f shorter and to make the connecting member 23 smaller to accommodate or carry the member 23 when it is not used. On the other hand, hooks 23g which can be attached to and detached from the grooves of the rail members 3a, 3b are employed as the connecting members 23 provided to the rear wires 21g, 21h.

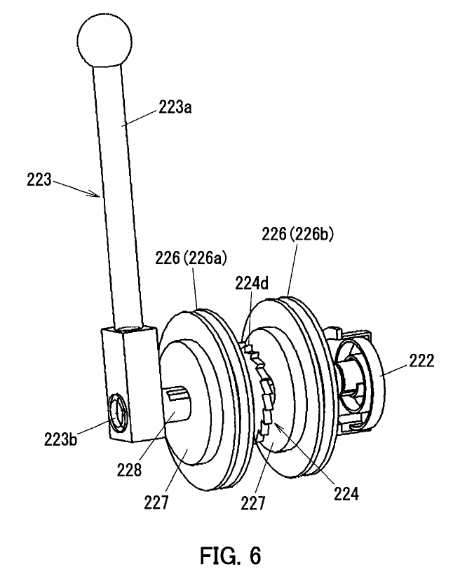

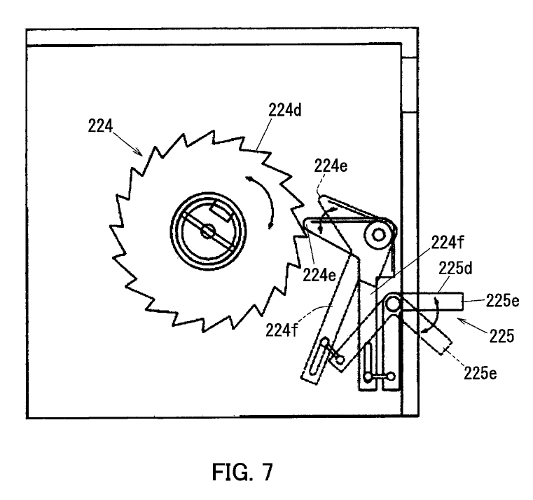

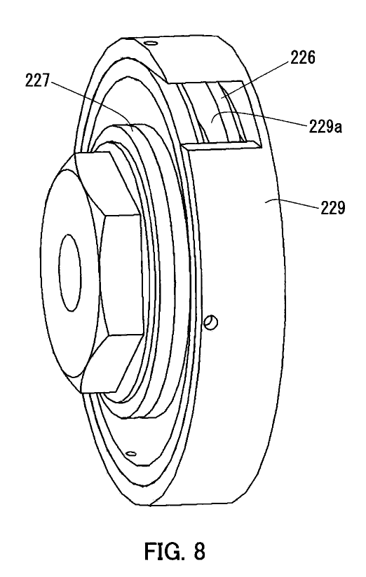

As the winding devices 22, devices which can wind up and accommodate both the front wires 21e, 21f and rear wire 21g or 21h is employed. The winding device 22 employed in the embodiment includes pulleys 226, disc springs 227, a rotary shaft 228, springs 222, a pulling device 223, a lock mechanism 224, and a canceling mechanism 225 as shown in FIGS. 6 and 7.

The pulleys 226 have functions of winding up the linear members 21. In the embodiment, two pulleys 226 are provided to respectively correspond to both of the two front wires 21e, 21f functioning as the linear members 21. The pulley 226a (hereafter referred to as “first pulley”) corresponding to one front wire 21e out of the front wires 21e, 21f is mounted with an end portion of the one front wire 21e and the one front wire 21e is wound up by the first pulley 226a as the first pulley 226a rotates in one direction. On the other hand, the pulley 226b (hereafter referred to as “second pulley”) corresponding to the other front wire 21f is mounted with an end portion of the other front wire 21f and the other front wire 21f is wound up by the second pulley 226b as the second pulley 226b rotates in one direction.

The disc springs 227 are disposed on opposite sides of each of the pulleys 226 to pinch the pulleys 226 and have a function of transmitting power for rotating the rotary shaft 228 to the pulleys 226 to rotate the pulleys 226 in a normal condition and interrupting transmission of power to the pulleys 226 when they reach a limit of their pinching force. In the embodiment, the disc springs 227 are provided to respectively correspond to the first pulley 226a and the second pulley 226b.

The rotary shaft 228 has a function of supporting the disc springs 227. The first pulley 226a, the second pulley 226b, and the disc springs 227 described above rotate about the rotary shaft 228.

The spring 222 has a function of applying rotating force in one direction to the rotary shaft 228. In the embodiment, a spiral spring is used as the spring 222.

The pulling device 223 includes an operation lever 223a and a one-way clutch 223b similarly to that in the embodiment 1. The operation lever 223a is coupled to the rotary shaft 228 through the one-way clutch 223b. The operation lever 223a can be swung and power for rotating the rotary shaft 228 is generated by operating the operation lever 223a. The one-way clutch 223b exists between the operation lever 223a and the rotary shaft 228 and has a function of transmitting the power to the rotary shaft 228 only when the operation lever 223a is operated in one direction.

With this pulling device 223, when the operation lever 223a is operated in one direction, the one-way clutch 223b is driven to transmit the power generated by the movement of the operation lever 223a to the rotary shaft 228 to thereby rotate the disc springs 227 in one direction together with the rotary shaft 228. As a result, the first and second pulleys 226a, 226b rotate. Therefore, the front wires 21e, 21f functioning as the linear members 21 are pulled in the wound-up direction. On the other hand, when the operation lever 223a is operated in a reverse direction, the one-way clutch 223b idles and the power generated by the movement of the operation lever 223a is not transmitted to the rotary shaft 228. Therefore, the rotary shaft 228 does not rotate and the front wires 21e, 21f are not pulled in.

If this pulling device 223 is used, by only repeating simple and easy operation in which the operation lever 223a is swung, i.e., the operation lever 223a is operated in one direction and then operated in the reverse direction, it is possible to increase tension generated in the front wires 21e, 21f.

The lock mechanism 224 has a function of preventing the linear members 21 from being drawn out. The lock mechanism 224 employed in the embodiment prevents only drawing out of the linear members 21 and includes a ratchet 224d and a stopper 224f having a pawl 224e to be engaged with the ratchet 224d as shown in FIGS. 6 and 7. The ratchet 224d is supported on the rotary shaft 228 and rotates with the rotary shaft 228. The stopper 224f has a function of preventing rotation of the ratchet 224d by engagement of the pawl 224e with the ratchet 224d to lock the wires. In the locked state, the rotary shaft 228 cannot rotate and therefore the first and second pulleys 226a, 226b do not rotate and drawing out of the front wires 21e, 21f is prevented.

The canceling mechanism 225 has a function of canceling a locked state by the lock mechanism 224. As the canceling mechanism 225, the mechanism having a structure that can maintain the cancelled state is preferable. The canceling mechanism 225 employed in the embodiment is formed of a substantially L-shaped operation portion 225d linked with the stopper 224f as shown in FIG. 7. The canceling mechanism 225 can cancel engagement between the pawl 224e of the stopper 224f and the ratchet 224d and can maintain the cancelled state by pushing down one end 225e of the operation portion 225d in a direction of gravity. In other words, the one end 225e of the operation portion 225d pushed down in the direction of gravity does not rotate in an opposite direction to the direction of gravity unless it receives external force and therefore the cancelled state is maintained. Consequently, with the canceling mechanism 225, the cancelled state is maintained and the wires are not locked even if a hand for operating the operation portion 225d is released from the operation portion 225d. Therefore, only one hand is necessary for operation in drawing the linear members 21 out of the winding devices 22.

The winding device 22 includes the same second rotor 221b and the same spring 222 acting on the second rotor 221b as those employed in the embodiment 1 as shown in FIG. 5. An end portion of the rear wire 21g or 21h is mounted to the second rotor 221b and the rear wire 21g or 21h is wound up by the second rotor 221b as the second rotor 221b rotates in one direction.

It is preferable that each of the pulleys 226 is mounted with a cover 229 having an opening portion 229a through which the linear member 21 goes in and out (see FIG. 8). The cover 229 is mounted independently of the pulley 226 so as not to rotate following rotation of the pulley 226. Therefore, the cover 229 does not rotate when the pulley 226 rotates and the opening portion 229a is always open in a fixed position. As a result, the cover 229 functions as a guide of the linear member 21 when the linear member 21 is drawn out of the pulley 226 or the linear member 21 is wound up by the pulley 226 and the linear member 21 is smoothly drawn out of the pulley 226 or smoothly wound up by the pulley 226.

The winding devices 22 of the wheelchair fixing apparatus 2 formed as described above are disposed at lower portions of armrests 1a and 1b of the wheelchair 1 as shown in FIG. 5. By disposing the winding devices 22 at the lower portions of the armrests 1a and 1b of the wheelchair 1 in this manner, points on which the linear members 21 act are located not at lower portions of the wheelchair 1 but at the lower portions of the armrests 1a and 1b and the linear members 21 can act on higher positions of the wheelchair 1. Therefore, it is possible to generate fixing force that can sufficiently resist a horizontal load and a vertical load (and especially a load acting in an opposite direction to a direction of gravity) applied to the wheelchair 1.

In the embodiment, as shown in FIG. 5, guides 24a, 24b having holes through which the front wires 21e, 21f are inserted are provided to frames near the armrests 1a, 1b and the front wires 21e, 21f are respectively drawn out through the guides 24a, 24b.

In the embodiment, the winding device 22 that can wind up the front wires 21e, 21f and one of the rear wires 21g is disposed at the lower portion of one of the armrests 1a and the winding device 22 that can wind up only the other rear wire 21h is disposed at the other armrest 1b. In this way, both of the linear members 21 (front wires 21e, 21f) connected to the fixing hardware pieces 3 through the connecting members 23 can be wound up on the front side of the wheelchair 1 by the one winding device 22 disposed on the side of the one armrest 1a to thereby enhance ease of operation. It is needless to say that the winding device 22 for winding up one of the front wires 21e and one of the rear wires 21g can be disposed at the lower portion of one of the armrests 1a and the winding device 22 for winding up the other front wire 21f and the other rear wire 21h can be disposed at the lower portion of the other armrest 1b.

The wheelchair 1 according to the embodiment is used as follows. To fix the wheelchair 1 onto the floor, the rear wires 21g, 21h accommodated in the winding devices 22 are first drawn out and the hooks 23g provided to tip ends of the rear wires 21g, 21h are connected to rail members 3a, 3b installed on the floor. Next, the one end 225e of the operation portion 225d of the canceling mechanism 225 is pushed down in the direction of gravity to cancel engagement between the pawl 224e of the stopper 224f and the ratchet 224d. In this way, the locked state by the lock mechanism 224 is cancelled and the front wires 21e, 21f accommodated in the winding devices 22 can be drawn out. Then, the handles 23f of the connecting members 23 are gripped, the front wires 21e, 21f accommodated in the winding device 22 are drawn out, and the engagement portions 23e provided to tip ends of the connecting members 23 are engaged with the hook holders 3c, 3d disposed on the floor. At last, the one end 225e of the operation portion 225d of the canceling mechanism 225 is pushed up in the opposite direction to the direction of gravity to engage the pawl 224e of the stopper 224f and the ratchet 224d with each other. As a result, the lock mechanism 224 is actuated to lock the front wires 21e, 21f and drawing out of the front wires 21e, 21f is prevented.

When the front wires 21e, 21f and the rear wires 21g, 21h are connected to the fixing hardware pieces 3 through the connecting members 23 in the above manner, tension is generated in each of the front wires 21e, 21f and the rear wires 21g, 21h. In other words, the winding device 22 employed in the embodiment includes the springs 222 for applying the rotating forces in one direction to the rotary shaft 228 and the second rotor 221b. Therefore, if connection of the rear wires 21g, 21h is completed, the second rotors 221b rotate in one direction due to the forces of the springs 222 to draw in the rear wires 21g, 21h in the winding up direction. Moreover, if connection of the front wires 21e, 21f is completed, the rotary shaft 228 rotates in one direction due to the force of the spring 222 and, as a result, the first and second pulleys 226a, 226b rotate in one direction to draw in the front wires 21e, 21f in the winding up direction. Therefore, in the state in which the front wires 21e, 21f and the rear wires 21g, 21h are connected to the fixing hardware pieces 3 through the connecting members 23, the slack is taken out of each of the front wires 21e, 21f and rear wires 21g, 21h by the operation of the springs 222 and the tension is generated in each of the front wires 21e, 21f and rear wires 21g, 21h.

To further increase the force for fixing the wheelchair 1, the operation lever 223a forming the pulling device 223 is swung. As a result, the rotary shaft 228 rotates in one direction and, as a result, the first and second pulleys 226a, 226b rotate in one direction to wind up the front wires 21e, 21f. Therefore, the tension generated in each of the front wires 21e, 21f and rear wires 21g, 21h is further increased to firmly fix the wheelchair 1.

If the pinching forces of the disc springs 227 respectively pinching the first and second pulleys 226a, 226b reach their limits, transmission of power to the first and second pulleys 226a, 226b is interrupted and rotation of the first and second pulleys 226a, 226b stops and therefore equal tension can be generated in both of the front wires 21e, 21f. In other words, if the tension generated in one of the front wires 21e exceeds a predetermined value and the pinching force of the disc springs 227 reaches its limit, for example, rotation of the first pulley 226a stops because the power of the rotary shaft 228 is not transmitted to the first pulley 226a even if the rotary shaft 228 is rotated. At this time, if the tension generated in the other front wire 21f has not reached the predetermined value, the second pulley 226b continues to rotate to wind up the other front wire 21f. Then, if the tension generated in the other front wire 21f exceeds the predetermined value and the pinching force of the disc springs 227 reaches its limit, rotation of the second pulley 226b stops because the power of the rotary shaft 228 is not transmitted to the second pulley 226b even if the rotary shaft 228 is rotated. As a result, the tension generated in the one front wire 21e and that in the other front wire 21f are equalized. Consequently, it is possible to fix the wheelchair 1 in balance.

Furthermore, excessive loads on the pulleys 226 and the like can be prevented by the operation of the disc springs 227 and therefore it is possible to prevent damage to the apparatus. Moreover, by arbitrarily setting the pinching forces of the disc springs 227, the tension generated in each of the linear members 21 can be set of a predetermined value.

In the wheelchair 1 of the embodiment, similarly to the wheelchair 1 of the embodiment 1, because the winding devices 22 are disposed at the lower portions of the armrests 1a, 1b and the operation lever 223a is under a hand of the user of the wheelchair, the user of the wheelchair can operate the operation lever 223a by himself/herself. This is also true of operation of the operation portion 225d of the canceling mechanism 225 and drawing out of the front wires 21e, 21f and the rear wires 21g, 21h described above. Therefore, the user of the wheelchair can perform the fixing operation by himself/herself. Even in a case in which a caretaker (including a person who is not attending on the user for the purpose of care) performs the fixing operation of the wheelchair 1, the operation is easy and therefore the burden on the caretaker in performing the operation can be reduced.

Furthermore, according to the embodiment, because each of the connecting members 23 includes the engagement portion 23e to be engaged with the fixing hardware piece 3 and the handle 23f provided at its tip end with the engagement portion 23e, it is possible to grip the handle 23f and attach the connecting member 23 to the fixing hardware piece 3. Consequently, it is possible to attach the connecting member 23 to the fixing hardware piece 3 without bending a body so much to the front and therefore a user of the wheelchair who has difficulty in bending his/her upper body can fix the wheelchair 1 alone.

Moreover, according to the wheelchair 1 of the embodiment, similarly to the embodiment 1, the fixing hardware pieces 3 to which the linear members 21 are connected through the connecting members 23 suffice as the floor-side equipment and it is possible to minimize the floor-side equipment. Therefore, it is possible to improve the environment for the usage of the wheelchair 1.

What is claimed is:

1. A wheelchair fixing apparatus comprising: a connecting member which can be attached to and detached from a fixing hardware piece installed on a floor; a linear member to which the connecting member is attached; and a winding device for winding up and accommodating the linear member, wherein the winding device is disposed on the wheelchair.

2. The wheelchair fixing apparatus according to claim 1, wherein the winding device includes a rotor for winding up the linear member and a spring for applying rotating force in one direction to the rotor.

3. The wheelchair fixing apparatus according to claim 1, wherein the winding device includes a pulling device for pulling the linear member in a winding-up direction.

4. The wheelchair fixing apparatus according to claim 3, wherein the pulling device includes an operation lever provided to be swung and a one-way clutch provided between the operation lever and the rotor for winding up the linear member to transmit power to the rotor only when the operation lever is operated in one direction.

5. The wheelchair fixing apparatus according to claim 1, wherein the winding device includes: a pulley for winding up the linear member; disc springs disposed on opposite sides of the pulley for pinching the pulley; and a rotary shaft for supporting the disc springs, the disc springs are caused to rotate by rotating the rotary shaft, the pulley rotates as the disc springs rotate, and transmission of power to the pulley is interrupted and only the disc springs rotate even if the rotary shaft is rotated when pinching forces of the disc springs reach their limits.

6. The wheelchair fixing apparatus according to claim 5, wherein the number of the pulley provided is two, the disc springs are provided to correspond to each of the pulleys, one of the pulleys winds up one of the linear members connected to the fixing hardware piece through the connecting member on a front side or a rear side of the wheelchair, and the other pulley winds up the other linear member connected to the fixing hardware piece through the connecting member on the front side or the rear side of the wheelchair.

7. The wheelchair fixing apparatus according to claim 5, wherein the winding device includes a spring for applying a rotating force in one direction to the rotary shaft.

8. The wheelchair fixing apparatus according to claim 5, wherein the winding device includes a pulling device for pulling the linear member in a winding-up direction.

9. The wheelchair fixing apparatus according to claim 8, wherein the pulling device includes an operation lever provided to be swung and a one-way clutch provided between the operation lever and the rotary shaft to transmit power to the rotary shaft only when the operation lever is operated in one direction.

10. The wheelchair fixing apparatus according to claim 1, wherein the winding device includes a lock mechanism for preventing the linear member from being drawn out and a canceling mechanism for canceling a locked state by the lock mechanism.

11. The wheelchair fixing apparatus according to claim 10, wherein the canceling mechanism can maintain a cancelled state.

12. The wheelchair fixing apparatus according to claim 1, wherein the winding device is disposed at a lower portion of an armrest of the wheelchair.

13. The wheelchair fixing apparatus according to claim 1, wherein the connecting member includes an engagement portion to be engaged with the fixing hardware piece and a handle provided at its tip end with the engagement portion.

14. The wheelchair fixing apparatus according to claim 13, wherein the handle is telescopic.

15. A wheelchair comprising the wheelchair fixing apparatus according to claim 1.
